(19) United States
(12) Patent Application Publication
(10) Pub. No.: US 2008/0130687 A1
(43) Pub. Date: Jun. 5, 2008

(54) Data Receiving Method and Transferring Method for Data Link Layer

(75) Inventors: Sam-Chul Ha, Kyungsangnam-do (KR); Seung-Myun Baek, Kyungsangnam-do (KR); Koon-Seok Lee, Kyungsangnam-do (KR); Yong-Tae Kim, Kyungsangnam-do (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 10/594,617

(22) PCT Filed: Mar. 31, 2005
(86) PCT No.: PCT/KR05/00944

§ 371 Date: Sep. 18, 2007

(30) Foreign Application Priority Data
Mar. 31, 2004 (KR) 10-2004-0022188
Mar. 31, 2004 (KR) 10-2004-0022189

(51) Int. Cl. H04J 3/00

(52) U.S. Cl. 370/498

(57) ABSTRACT

The present invention discloses a data transmission and receiving method at a data link layer for use in a home network system based on a living network control protocol. The data receiving method at the data link layer of a protocol that consists of a physical layer, a data link layer, and an upper layer, includes the steps of: receiving data from the physical layer, storing the received data in a packet buffer, deciding whether new data has been received within a predetermined data allowable interval time since last data is received; and based on a result of the first decision, completing receiving the data.

### TECHNICAL FIELD

The present invention relates to a data receiving method and transferring method for data link layer, and more particularly to, a data receiving method and transferring method for data link layer for use in an LnCP (Living network Control Protocol)—based home network system.

### BACKGROUND ART

A home network connects various digital home appliances so that the user can always enjoy convenient, safe and economic life services inside or outside the house. Refrigerators or washing machines called white home appliances have been gradually digitalized due to the development of digital signal processing techniques, home appliance operating system techniques and high speed multimedia communication techniques have been integrated on the digital home appliances, and new information home appliances have been developed, to improve the home network.

As shown in Table 1, the home network is classified into a data network, an entertainment network and a living network by types of services.

TABLE 1

| Classification | Function | Service type |
|---|---|---|
| Data network | Network between PC and | Data exchange, internet |
| | peripheral devices | service, etc. |
| Entertainment | Network between A/V | Music, animation service, |
| network | devices | etc. |
| Living | Network for controlling | Home appliances control, |
| network | home appliances | home automation, remote |
| | | meter reading, message |
| | | service, etc. |

Here, the data network is built to exchange data between a PC and peripheral devices or provide an internet service, and the entertainment network is built between home appliances using audio or video information. In addition, the living network is built to simply control home appliances, such as home automation or remote meter reading.

A conventional home network system includes a master device which is an electric device for controlling an operation of the other electric devices or monitoring a status thereof, and a slave device which is an electric device having a function of responding to the request of the master device and a function of notifying a status change according to characteristics of the electric devices or other factors. Exemplary electric devices include home appliances for the living network service such as a washing machine and a refrigerator, home appliances for the data network service and the entertainment network service, and products such as a gas valve control device, an automatic door device and an electric lamp.

However, the conventional arts do not suggest a general communication standard for providing functions of controlling and monitoring electric devices in a home network system. Also, a network protocol in the conventional art home network system does not suggest an effective method for transmitting and receiving a packet.

### DISCLOSURE OF THE INVENTION

The present invention is achieved to solve the above problems. An object of the present invention is to provide data receiving method and transferring method for data link layer for use in a home network system based on a control protocol which is a general communication standard for providing functions of controlling and monitoring electric devices in the home network system.

It is another object of the present invention to provide a data receiving method at a data link layer for receiving a plurality of only the relevant frames to a packet to be composed.

It is still another object of the present invention to provide a data receiving method at a data link layer for preventing an additional frame from being received and/or stored when a packet is already being composed of a plurality of received frames relevant to the packet.

It is still another object of the present invention to provide a data transmission method at a data link layer for more effectively transmitting a packet from an upper layer, according to the status of a network.

It is still another object of the present invention to provide a data transmission method at a data link layer for preventing a packet collision over a network.

It is still another object of the present invention to provide a data transmission method at a data link layer for completing data transmission according to a retry count during packet transmission.

It is still another object of the present invention to provide a data transmission method at a data link layer for completing data transmission according to a transmission execution time spent in packet transmission.

It is yet another object of the present invention to provide a data transmission method at a data link layer for increasing successful packet retransmission probability, by applying a variable transmission delay to packet transmission.

In order to achieve the above-described objects of the invention, there is provided a data receiving method for data link layer of a protocol consisting of a physical layer, a data link layer, and an upper layer, which the method includes the steps of: receiving data from the physical layer; storing the received data in a packet buffer; deciding whether new data has been received within a predetermined data allowable interval time since last data is received; and based on a result of the first decision, completing receiving the data.

Another aspect of the present invention provides a data transferring method for data link layer, wherein the data link layer is of a protocol having at least a physical layer, a data link layer and an upper layer, and a network based on the protocol is used for intercommunication between at least one electric device and at least one network manager in a home network system, and the data link layer transmits a packet from the upper layer to the physical layer, which the method includes the steps of: a first checking step for checking whether the network status is in an idle status; according to a result of the first checking step, selecting a transmission delay time (RandomDelayTime); a second checking step for checking whether the network status is an idle status during the selected transmission delay time (RandomDelayTime); and according to a result of the second checking step, transmitting the received packet to the physical layer.

Still another aspect of the present invention provides a data transferring method for data link layer, wherein the data link layer is of a protocol having at least a physical layer, a data link layer and an upper layer, and a network based on the protocol is used for intercommunication between at least one electric device and at least one network manager in a home network system, and the data link layer transmits a packet from the upper layer to the physical layer, which the method includes the steps of: checking whether the network status is in an idle status; according to a result of the checking step, transmitting the received packet to the physical layer; and deciding whether the packet is successfully transmitted.

Yet another aspect of the present invention provides a data transferring method for data link layer, wherein the data link layer is of a protocol having at least a physical layer, a data link layer and an upper layer, and a network based on the protocol is used for intercommunication between at least one electric device and at least one network manager in a home network system, and the data link layer transmits a packet from the upper layer to the physical layer, which the method includes the steps of: a first checking step for checking whether the network status is in an idle status; according to a result of the first checking step, selecting a transmission delay time (RandomDelayTime) within a predetermined competitive window (Wc) range defined according to service priority SvcPriority of the received packet; a second checking step for checking whether the network status is an idle status during the selected transmission delay time (RandomDelayTime); and according to a result of the second checking step, transmitting the received packet to the physical layer.

### BRIEF DESCRIPTION OF THE DRAWINGS

FIG. 1 is a structure view illustrating a home network system in accordance with the present invention;

FIG. 2 is a structure view illustrating a living network control protocol stack in accordance with the present invention;

FIGS. 3 and 4 are structure views illustrating interfaces between layers of FIG. 2, respectively;

FIGS. 5 to 10 are detailed structure views illustrating the interfaces of FIGS. 3 and 4, respectively; and

FIG. 11 is a flow chart explaining a data receiving method for data link layer in accordance with the present invention;

FIG. 12 illustrates frames that are processed by a data receiving method in accordance with the present invention;

FIG. 13 is a flow chart explaining a data transmission method for data link layer in accordance with the present invention; and

FIG. 14 illustrates frames that are processed in each electric device by a data transmission method in accordance with the present invention.

### BEST MODE FOR CARRYING OUT THE INVENTION

A data receiving method and transferring method for data link layer in accordance with the present invention will now be described in detail with reference to the accompanying drawings.

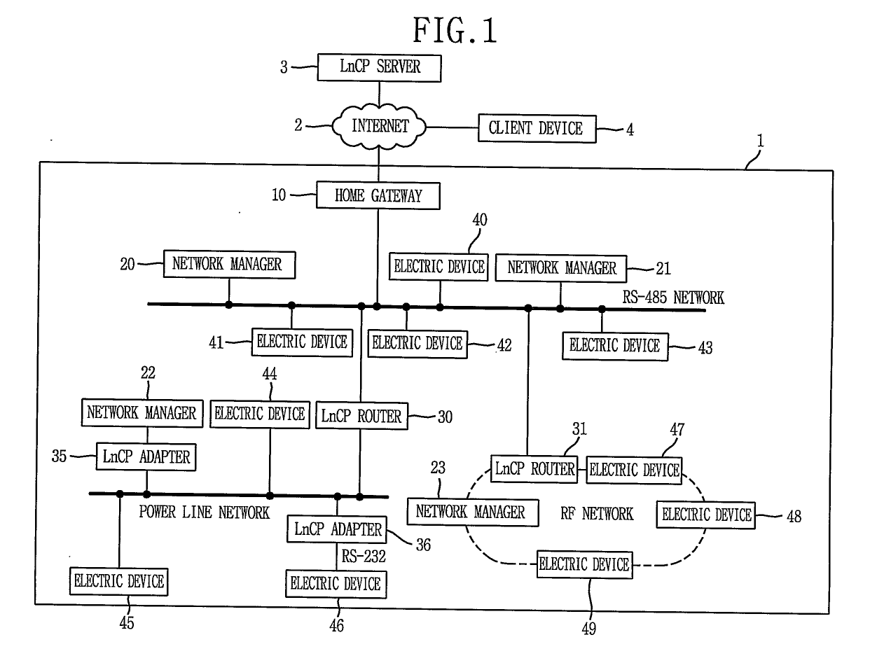

FIG. 1 is a structure view illustrating the home network system in accordance with the present invention.

Referring to FIG. 1, the home network system 1 accesses an LnCP server 3 through an internet 2, and a client device 4 accesses the LnCP server 3 through the internet 2. That is, the home network system 1 is connected to communicate with the LnCP server 3 and/or the client device 4.

An external network of the home network system 1 such as the internet 2 includes additional constitutional elements according to a kind of the client device 4. For example, when the client device 4 is a computer, the internet 2 includes a Web server (not shown), and when the client device 4 is an internet phone, the internet 2 includes a Wap server (not shown).

The LnCP server 3 accesses the home network system 1 and the client device 4 according to predetermined login and logout procedures, respectively, receives monitoring and control commands from the client device 4, and transmits the commands to the network system 1 through the internet 2 in the form of predetermined types of messages. In addition, the LnCP server 3 receives a predetermined type of message from the home network system 1, and stores the message and/or transmits the message to the client device 4. The LnCP server 3 also stores or generates a message, and transmits the message to the home network system 1. That is, the home network system 1 accesses the LnCP server 3 and downloads provided contents.

The home network system 1 includes a home gateway 10 for performing an access function to the internet 2, network managers 20 to 23 for performing a function of setting an environment and managing electric devices 40 to 49, LnCP routers 30 and 31 for access between transmission media, LnCP adapters 35 and 36 for connecting the network manager 22 and the electric device 46 to the transmission medium, and the plurality of electric devices 40 to 49.

The network of the home network system 1 is formed by connecting the electric devices 40 to 49 through a shared transmission medium. A data link layer uses a non-standardized transmission medium such as RS-485 or small output RF, or a standardized transmission medium such as a power line and IEEE 802.11 as the transmission medium.

The network of the home network system 1 is separated from the internet 2, for composing an independent network for connecting the electric devices through wire or wireless transmission medium. Here, the independent network includes a physically-connected but logically-divided network.

The home network system 1 includes master devices for controlling operations of the other electric devices 40 to 49 or monitoring statuses thereof, and slave devices having functions of responding to the request of the master devices and notifying their status change information. The master devices include the network managers 20 to 23, and the slave devices include the electric devices 40 to 49. The network managers 20 to 23 include information of the controlled electric devices 40 to 49 and control codes, and control the electric devices 40 to 49 according to a programmed method or by receiving inputs from the LnCP server 3 and/or the client device 4. Still referring to FIG. 1, when the plurality of network managers 20 to 23 are connected, each of the network managers 20 to 23 must be both the master device and the slave device, namely physically one device but logically the device (hybrid device) for simultaneously performing master and slave functions in order to perform information exchange, data synchronization and control with the other network managers 20 to 23.

In addition, the network managers 20 to 23 and the electric devices 40 to 49 can be connected directly to the network (power line network, RS-485 network and RF network) or through the LnCP routers 30 and 31 and/or the LnCP adapters 35 and 36.

The electric devices 40 to 49 and/or the LnCP routers 30 and 31 and/or the LnCP adapters 35 and 36 are registered in the network managers 20 to 23, and provided with intrinsic logical addresses by products (for example, 0x00, 0x01, etc.). The logical addresses are combined with product codes (for example, 0x02 of air conditioner and 0x01 of washing machine), and used as node addresses. For example, the electric devices 40 to 49 and/or the LnCP routers 30 and 31 and/or the LnCP adapters 35 and 36 are identified by the node addresses such as 0x0200 (air conditioner 1) and 0x0201 (air conditioner 2). A group address for identifying at least one electric device 40 to 49 and/or at least one LnCP router 30 and 31 and/or at least one LnCP adapter 35 and 36 at a time can be used according to a predetermined standard (all identical products, installation space of products, user, etc.). In the group address, an explicit group address is a cluster for designating a plurality of devices by setting an address option value (flag mentioned below) as 1, and an implicit group address designates a plurality of devices by filling the whole bit values of the logical addresses and/or the product codes with 1. Especially, the implicit group address is called a cluster code.

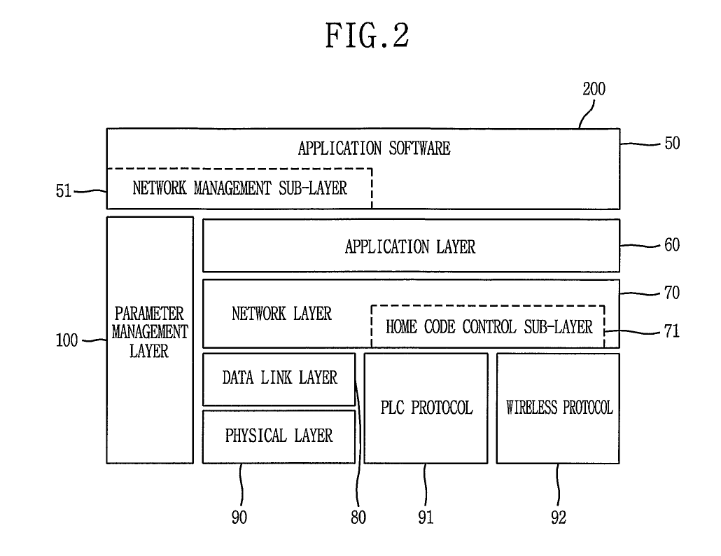

FIG. 2 is a structure view illustrating a living network control protocol stack in accordance with the present invention. The home network system 1 enables the network managers 20 to 23, the LnCP routers 30 and 31, the LnCP adapters 35 and 36 and the electric devices 40 to 49 to communicate with each other according to the living network control protocol (LnCP) of FIG. 2. Therefore, the network managers 20 to 23, the LnCP routers 30 and 31, the LnCP adapters 35 and 36 and the electric devices 40 to 49 perform network communication according to the LnCP.

As illustrated in FIG. 2, the LnCP includes an application software 50 for performing intrinsic functions of the network managers 20 to 23, the LnCP routers 30 and 31, the LnCP adapters 35 and 36 and the electric devices 40 to 49, and providing an interface function with an application layer 60 for remote controlling and monitoring on the network, the application layer 60 for providing services to the user, and also providing a function of forming information or a command from the user in the form of a message and transmitting the message to the lower layer, a network layer 70 for reliably network-connecting the network managers 20 to 23, the LnCP routers 30 and 31, the LnCP adapters 35 and 36 and the electric devices 40 to 49, a data link layer 80 for providing a medium access control function of accessing a shared transmission medium, a physical layer 90 for providing physical interfaces between the network managers 20 to 23, the LnCP routers 30 and 31, the LnCP adapters 35 and 36 and the electric devices 40 to 49, and rules for transmitted bits, and a parameter management layer 100 for setting and managing node parameters used in each layer.

In detail, the application software 50 further includes a network management sub-layer 51 for managing the node parameters, and the network managers 20 to 23, the LnCP routers 30 and 31, the LnCP adapters 35 and 36 and the electric devices 40 to 49 which access the network. That is, the network management sub-layer 51 performs a parameter management function of setting or using the node parameter values through the parameter management layer 100, and a network management function of composing or managing the network when the device using the LnCP is a master device.

When the network which the network managers 20 to 23, the LnCP routers 30 and 31, the LnCP adapters 35 and 36 and the electric devices 40 to 49 access is a dependent transmission medium such as a power line, IEEE 802.11 and wireless (for example, when the LnCP includes a PLC protocol and/or wireless protocol), the network layer 70 further includes a home code control sub-layer 71 for performing a function of setting, managing and processing home codes for logically dividing each individual network. When the individual networks are physically divided by an independent transmission medium such as RS-485, the home code control sub-layer 71 is not included in the LnCP. Each of the home codes is comprised of 4 bytes, and set as random values or designated values of the user.

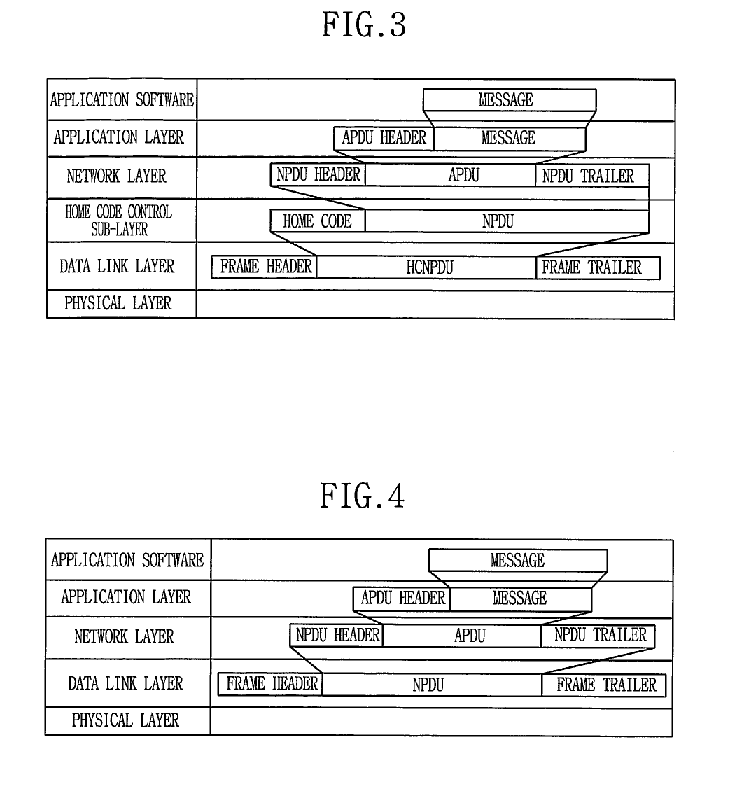

FIGS. 3 and 4 are structure views illustrating interfaces between the layers of FIG. 2, respectively.

FIG. 3 illustrates the interfaces between the layers when the physical layer 90 is connected to the non-independent transmission medium, and FIG. 4 illustrates the interfaces between the layers when the physical layer 90 is connected to the independent transmission medium.

The home network system 1 adds headers and trailers required by each layer to protocol data units (PDU) from the upper layers, and transmit them to the lower layers.

As shown in FIGS. 3 and 4, an application layer PDU (APDU) is a data transmitted between the application layer 60 and the network layer 70, a network layer PDU (NPDU) is a data transmitted between the network layer 70 and the data link layer 80 or the home code control sub-layer 71, and a home code control sub-layer PDU (HCNPDU) is a data transmitted between the network layer 70 (precisely, the home code control sub-layer 71) and the data link layer 80. The interface is formed in data frame units between the data link layer 80 and the physical layer 90.

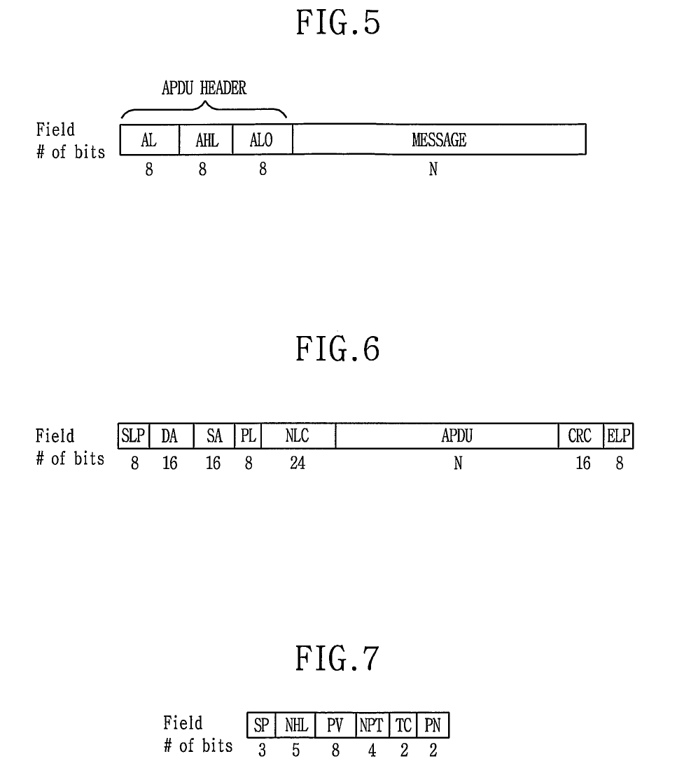

FIGS. 5 to 10 are detailed structure views illustrating the interfaces of FIGS. 3 and 4, respectively.

FIG. 5 illustrates the APDU structure in the application layer 60.

An APDU length (AL) field shows a length of the APDU (length from AL to message field), and has a minimum value of 4 and a maximum value of 77.

An APDU header length (AHL) field shows a length of an APDU header (length from AL to AL0), successfully has 3 bytes, and is extensible to 7 bytes. In the LnCP, the APDU header can be extended to 7 bytes to encode a message field and change an application protocol.

An application layer option (AL0) field extends a message set. For example, when the AL0 field is set as 0, if the AL0 field contains a different value, message processing is ignored.

The message field processes a control message from the user or event information, and is changed by the value of the AL0 field.

FIG. 6 illustrates the NPDU structure in the network layer 70, and FIG. 7 illustrates a detailed NLC structure of the NPDU.

A start of LnCP packet (SLP) field indicates start of a packet and has a value of 0x02.

Destination address (DA) and source address (SA) fields are node addresses of a receiver and a sender of a packet, and have 16 bits, respectively. The most significant 1 bit includes a flag indicating a group address, the succeeding 7 bits include a kind of a product (product code), and the lower 8 bits include a logical address for distinguishing the plurality of network managers 20 to 23 of the same kind and the plurality of electric devices 40 to 49 of the same kind. A packet length (PL) field shows the total length of NPDU which will be transferred, and its initial length is 15 bytes and its maximum length is 120 bytes.

A service priority (SP) field gives transmission priority to a transmission message and has 3 bits. Table 2 shows the priority of each transmission message.

When a slave device responds to a request of a master device, the slave device takes the priority of the request message from the master device.

TABLE 2

| Priority | Value | Message type |
|---|---|---|
| High | 0 | Security related message |
| Middle | 1 | When a normal packet is transmitted |
| | | When an event message for online or |
| | | offline status change is transmitted |
| Normal | 2 | When a notification message for composing |
| | | a network is transmitted |
| | | When a normal event message is transmitted |
| Low | 3 | When a data is transmitted by download |
| | | or upload mechanism |

An NPDU header length (NHL) field extends an NPDU header (NLC field of SLP), successfully has 9 bytes, and is extended to a maximum of 17 bytes.

A protocol version (PV) field indicates the employed protocol version and its length is 1 byte. The upper 4 bits show the version, and the lower 4 bits show the sub-version. Version and sub-version use HEX to show their values respectively.

A network layer packet type (NPT) field is a 4-bit field for distinguishing a kind of a packet in the network layer 70. The LnCP includes a request packet, a response packet and a notification packet. The NPT field of a master device must be set as the request packet or the notification packet, and the NPT field of a slave device must be set as the response packet or the notification packet. Table 3 shows NPT values by kinds of packets.

TABLE 3

| Explanation | Value |
|---|---|
| Request packet | 0 |
| reserved | 1~3 |
| Response packet | 4 |
| reserved | 5~7 |
| Notification packet | 8 |
| reserved | 9~12 |
| Reserved value for interface with | 13~15 |
| the home code control sub-layer | |

A transmission counter (TC) field is a 2 bit field which retransmits the request packet or repeatedly transfers notification packet in order to enhance the transmission success rate of the notification packet when a communication error occurs in the network layer 70, making it unable to transfer the request packet or response packet properly. Table 4 shows the range of the values of the TC field by the NPT values.

TABLE 4

| Kind of packet | Value (range) |
|---|---|
| Request packet | 1~3 |
| Response packet | 1 |
| Notification packet | 1~3 |

A packet number (PN) field consists of 2 bytes, and it is used with the TC to detect duplicated packets in the slave device, and it is used to deal with multiple communication cycles in the master device. Table 5 shows the range of the values of the PN field by the NPT values.

TABLE 5

| Kind of packet | Value (range) |
|---|---|
| Request packet | 0~3 |
| Response packet | Copy a PN field value |
| | of a request packet |
| Notification packet | 0~3 |

An APDU field is a protocol data unit of the application layer 60 transmitted between the application layer 60 and the network layer 70. The APDU field has a minimum value of 0 byte and a maximum value of 88 bytes.

A cyclic redundancy check (CRC) field is a 16-bit field for checking an error of a received packet (from SLP to APDU).

An end of LnCP packet (ELP) field is the end of the packet with the value 0x03. If the ELP field is not detected in spite of byte length of the received data is the same with the value of packet's length field, this packet will be c onsidered as an error packet.

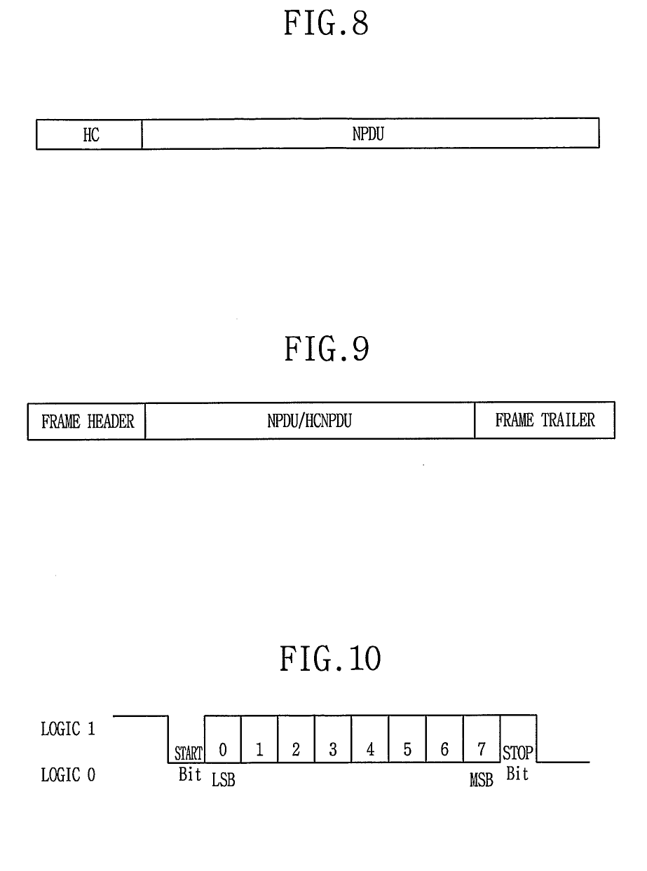

FIG. 8 illustrates the HCNPDU structure in the home code control sub-layer 71.

As depicted in FIG. 8, a home code (HC) field is added to the upper portion of the NPDU.

The home code is comprised of 4 bytes, and has a unique value within the line distance where a packet can be transmitted.

FIG. 9 illustrates a frame structure in the data link layer 80.

The structure of the header and the trailer of the data link layer frame of the LnCP is changed according to transmission media. When the data link layer 80 uses a non-standardized transmission medium, the header and the trailer of the frame must have null fields, and when the data link layer 80 uses a standardized transmission medium, the header and the trailer of the frame are formed as prescribed by the protocol. An NPDU field is a data unit transmitted from the upper network layer 70, and an HCNPDU field is a data unit obtained by adding 4 bytes of home code to the front portion of the NPDU, when the physical layer 90 is a dependent transmission medium such as a power line or IEEE 802.11. The data link layer 80 processes the NPDU and the HCNPDU in the same manner.

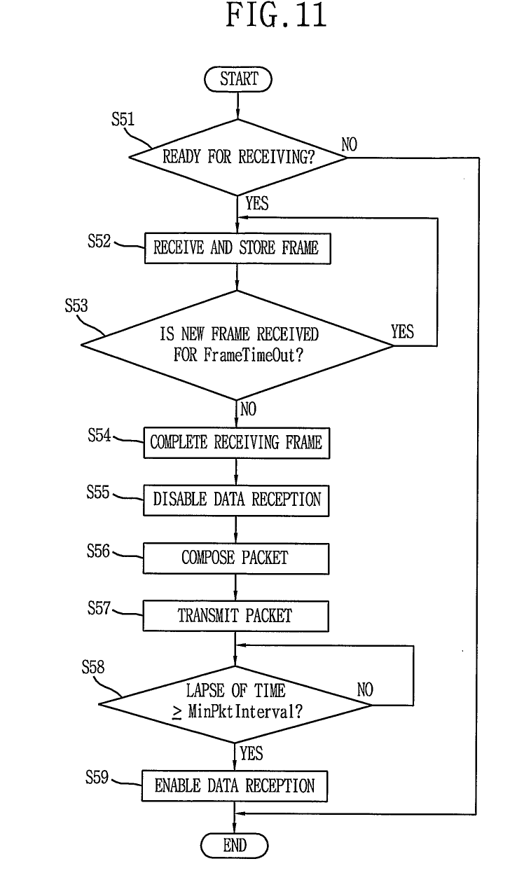

FIG. 10 illustrates a frame structure in the physical layer 90.

The physical layer 90 of the LnCP handles a function of transmitting and receiving a physical signal to a transmission medium. The data link layer 80 can use a non-standardized transmission medium such as RS-485 or small output RF or a standardized transmission medium such as a power line or IEEE. 802.11 as the physical layer 90 of the LnCP. The home network system 1 using the LnCP employs a universal asynchronous receiver and transmitter (UART) frame structure and a signal level of RS-232, so that the network managers 20 to 23 and the electric devices 40 to 49 can interface with RS-485, the LnCP routers 30 and 31 or the LnCP adapters 35 and 36. When the UART is connected between the devices by using a serial bus, the UART controls flow of bit signals on a communication line. In the LnCP, a packet from the upper layer is converted into 10 bits of UART frame unit as shown in FIG. 10, and transmitted through the transmission medium. The UART frame includes one bit of start bit, 8 bits of data and one bit of stop bit without any parity bit. The start bit is transmitted first, followed by data bits and the stop bit. When the home network system 1 using the LnCP employs the UART, it does not have additional frame header and frame trailer. The node parameters used in the aforementioned layers will now be explained.

Data types of the node parameters mentioned below correspond to one of a few data types of Table 6.

TABLE 6

| Notation | Data type | Description |
|---|---|---|
| char | signed char | 1 byte when data length is not stated |
| uchar | unsigned char | 1 byte when data length is not stated |
| int | signed int | 2 bytes when data length is not stated |
| uint | unsigned int | 2 bytes when data length is not stated |
| long | signed long | 4 bytes when data length is not stated |
| ulong | unsigned long | 4 bytes when data length is not stated |
| string | string | A character string data where the last |
| | | byte is NULL |
| FILE | — | A data having a file structure |

The data link layer 80 prescribes a medium access control (MAC) function of accessing a shared transmission medium. When using a non-standardized transmission medium such as RS485, the data link layer 80 employs probabilistic-delayed carrier sense multiple access (p-DCSMA) as a medium access control protocol, and when using a standardized transmission medium such as a power line or IEEE 802.11, the data link layer 80 is prescribed by the corresponding protocol.

Table 7 shows node parameter values used in the data link layer 80 using the UART frame. The time of each parameter is set in the presumption that a transmission rate of the physical layer 90 is 4800 bps. Here, one information unit time (IUT) is calculated as 2.1 ms.

TABLE 7

| Name | Type | Explanation |
|---|---|---|
| Frame permitted | constant uchar | A maximum time interval permitted between UART frames |
| time interval | FrameTimeOut | when receiving packets, 2 IUT |
| Maximum frame | constant uchar | A maximum time interval permitted between UART frames |
| permitted time interval | MaxFrameInterval | when transmitting packets, 1 IUT |
| Minimum packet | uint | A minimum time interval permitted between two consecutive |
| Permitted time interval | MinPktInterval | packets transmitted on a medium in packet transmission, |
| | | over 5 IUT. A time for transmitting a packet received by |
| | | the data link layer 80 to the application layer 60 and finishing |
| | | packet processing must be smaller than this value. |
| Backoff repeat times | constant uchar | A maximum repeat times of a MAC algorithm due to |
| | BackOffRetries | arbitration failure or data collision, 10 times |
| Maximum transmission | constant uint | An allowable execution time (ms) of a MAC algorithm, 1000 |
| allowable time | MACExecTime | ms |
| Busy check time | constant uchar | A time for detec the status of medium (busy or idle), 3 IUT |
| | BusyCheckTime | |
| Transmission delay | uint | A standby time for transmission when a medium is in an idle |
| time | RandomDelayTime | status, random value within a competitive window Wc range |
| | | selected by SvcPriority value |

FIG. 11 is a flow chart explaining a data receiving method for data link layer in accordance with the present invention

Referring to FIG. 11, in step S51, before or after a frame from the physical layer 90 is transmitted, it is decided whether the data link layer 80 is ready for receiving the frame. If the data link layer 80 has generated another packet with the already received frames, or is in the middle of packet transmission (i.e., S56˜S58 to be described), it is decided that the data link layer 80 is not ready for receiving the frame. Thus, the received frame is not processed and the data receiving method ends here. However, if it turns out that the data link layer 80 is ready for receiving the frame, the method proceeds to the next step S52.

In step S52, the data link layer 80 receives the frame from the physical layer 90, and stores it in a packet buffer (not shown). In effect, the data link layer 80 sequentially receives a plurality of frames from the physical layer 90 in order to compose a packet, and stores them in the packet buffer.

In step S53, the data link layer 80 compares an interval between the last transmitted frame with a new frame (hereinafter the interval will be referred to simply as ‘frame interval’) with a Frame permitted time interval FrameTimeOut. If the frame interval is smaller than the Frame permitted time interval FrameTimeOut, that is, if a new frame has been received within the Frame permitted time interval FrameTimeOut since the last frame, it means that the last frame and the new frame should be included in the same packet. In this case, the data link layer 80 performs the step of receiving and storing the new frame in the packet buffer (i.e., S52). On the other hand, if the frame interval is greater or equal to the Frame permitted time interval FrameTimeOut, that is, if a new frame is not transmitted within the Frame permitted time interval FrameTimeOut, it means that the last frame and the new frame should be included in different packets from each other. Therefore, the data link layer 80 stores previously received frames (including the last frame) up to that point in the packet buffer, and the method proceeds to the next step S54.

In step S54, the data link layer 80 deems the frames that have the frame interval smaller than the Frame permitted time interval FrameTimeOut are of the same packet, and receives no more frames from the physical layer 90.

Accordingly, in step S55, the data link layer 80 diable its frame reception from the physical layer 90. This state is maintained at least for the minimum packet permitted time interval MinPktInterval after the completion of receiving the (necessary) frames, so that a new frame cannot be overlapped in the packet buffer.

In step S56, the data link layer 80 composes a packet NPDU of the frames stored in the packet buffer.

In step S57, the data link layer 80 transmits the packet NPDU to the network layer 70 which is the upper layer.

In step S58, the data link layer 80 awaits until the passage of time after the completion of receiving the frames to be equal or greater than the minimum packet permitted time interval MinPktInterval. Then, in step S59, the data link layer 80 enable its frame reception from the physical layer 90. In other words, the data link layer 80 is now able to receive new frames and compose a packet thereof.

Here, the minimum packet permitted time interval MinPktInterval is set to a greater value than the interval between the completion time of receiving frames and a time for transmitting the packet NPDU to the application layer 60 through the network layer 70 and finishing packet processing. This makes sure that the data link layer 80 is not ready for receiving a new frame or packet until the received frames or the packet thereof is completely processed. In this manner, receiving a plurality of frames or the packet thereof at the same layer, and their processing and transmission are not executed at the same time. Therefore, the receiving, processing and transmission of the frames or the packet can be performed more stably.

The above-described data receiving method is stored in a predetermined storage means or storage medium in form of a software program.

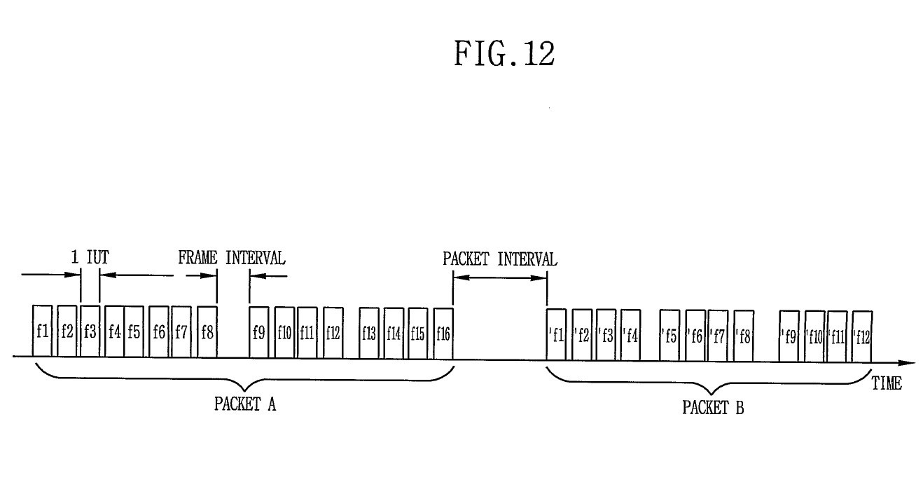

FIG. 12 illustrates frames that are processed by a data receiving method of the present invention.

As depicted in FIG. 12, a packet A includes frames f1-f16. The data link layer 80 receives the frame f1 first (S52), and this frame f1 becomes the last frame currently being received. After receiving the frame f1, another frame f2 is received within the Frame permitted time interval FrameTimeout (S53). This frame receiving process (i.e. S52 and S53) is repeated until the frame f16 is received. As can be seen in the drawing, the frame interval between the frames f8 and f9 is greater than other frame intervals, but it is still less than the Frame permitted time interval FrameTimeOut. Thus, the frames f8 and f9 are included in the same packet A.

Since there is no new frame ‘f1 received within the Frame permitted time interval FrameTimeOut after the last frame f16, the data link layer 80 composes the packet A of the frames f1-f16 only (S54).

Later, the data link layer 80 transmits the composed packet A, and when the packet interval becomes greater than the minimum packet permitted time interval MinPktInterval the data link layer 80 receives a new frame ‘f1 to compose a new packet B.

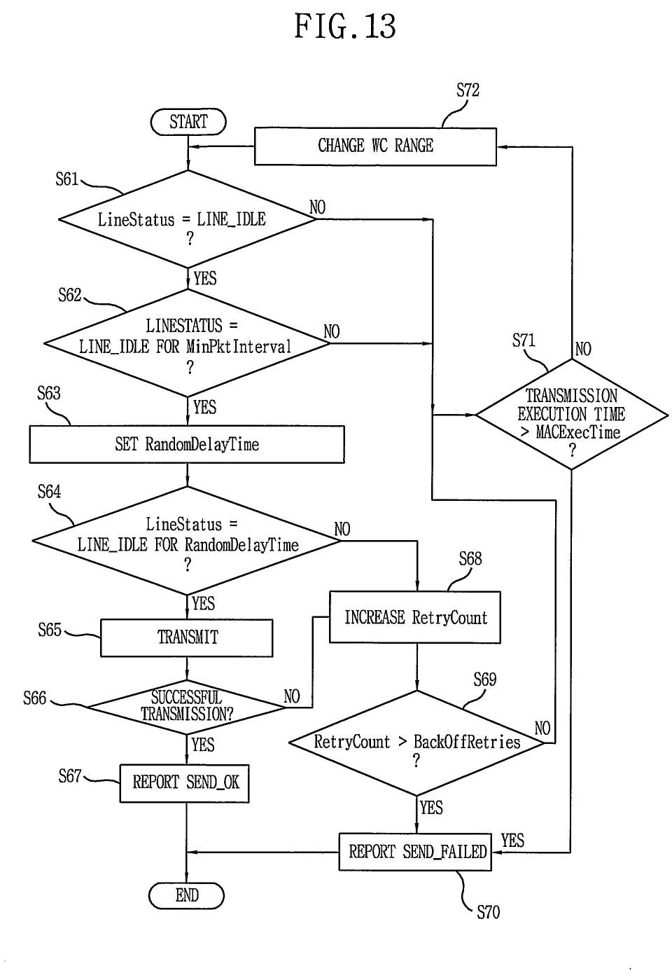

FIG. 13 is a flow chart explaining a data transmission method at a data link layer in accordance with the present invention.

As described above, the data link layer 80 receives the packet NPDU/HCNPDU from the network layer 70, and composes a frame by adding a frame header and a frame trailer. The composed frame is then transmitted to a network (e.g., power line network, RS-485 network, RF network, etc. shown in FIG. 1) through the physical layer 90. In the following description, when it says the data link layer 80 transmits a frame, it actually means that the data link layer 80 transmits a frame including the packet from the network layer 70. Therefore, the specification and claims of the present invention are based on the assumption that the data link layer 80 transmits the packet from the network layer 70 to the physical layer 90.

As for the transmission of the packet from the network layer 70, the retry count RetryCount is set to ‘0’.

Referring now to FIG. 13, in step S61, the data link layer 80 checks whether network status LineStatus is in an idle status LINE_IDLE. To this end, the data link layer 80 receives information on the network status from the physical layer 90. If the network status LineStatus is in an idle status LINE_IDLE, the method proceeds to the next step S62, whereas if the network status LineStatus is busy LINE_BUSY, the method proceeds to the step S71.

In step S62, the data link layer 80 checks whether the network status LineStatus is in an idle status LINE_IDLE for the minimum packet permitted time interval MinPktInterval. The minimum packet permitted time interval MinPktInterval is set in order to prevent data collision on the network when the network managers 20 to 23 and the electric devices 40 to 49 transmit data (packet) over the network. Therefore, for the same purpose in preventing data collision, the data link layers 80 for the network managers 20 to 23 and the electric devices 40 to 49 also check in step S62 whether the network status LineStatus is in an idle status LINE_IDLE for the minimum packet permitted time interval MinPktInterval. If the network status LineStatus becomes busy LINE_BUSY for the minimum packet permitted time interval MinPktInterval, the method proceeds to the step S71, but otherwise the method proceeds to the step S63.

In step S63, the data link layer 80 randomly selects the transmission delay time RandomDelayTime within a predetermined competitive window Wc range (refer to Table 8) by SvcPriority value of the received packet (the aforementioned service indicates the transmission service, so the service priority will be referred to as ‘transmission priority’ in the following description). Table 8 shows competitive window Wc ranges by transmission priority.

TABLE 8

| Transmission | | Competitive window |
|---|---|---|
| priority | Value | (Wc) range (IUT) |
| High | 0 | 0-5 |
| Middle | 1 | 10-20 |
| Normal | 2 | 10-30 |
| Low | 3 | 30-60 |

As shown in Table 8, the higher the priority value is, that is, the lower the priority is, the broader the competitive window Wc range is and its low limit is increased. For instance, in case of high priority, the lower limit of the Wc range is 0 and the upper limit thereof is 5. Similarly, in case of normal priority, the lower limit of the Wc range is 10 and the upper limit thereof is 30. Since the transmission delay time RamdomDelayTime is randomly selected out of the competitive window Wc range, the probability of selecting a smaller transmission delay time RamdomDelayTime is relatively higher in the smaller priority values.

In step S64, the data link layer 80 checks whether the network status LineStatus is in an idle status LINE_IDLE for the selected transmission delay time RandomDelayTime. Particularly, the step S64 is executed in order to prevent a packet collision on the network. If the network status LineStatus is busy LINE_BUSY, the method proceeds to the step S68. However, if the network status LineStatus is in an idle status LINE_IDLE for the transmission delay time RandomDelayTime, the method proceeds to the step S65.

In step S65, the data link layer 80 transmits the packet from the physical layer 90.

In step S66, the data link layer 80 decides whether the packet is successfully transmitted. To make the decision, the data link layer 80 compares the packet from the physical layer 90 with the packet the network layer 70. If those two packets are identical, the data link layer 80 decides that the packet transmission is successfully performed and thus, the method proceeds to the step S67. However, if the packets are not identical, the method proceeds to the step S68.

In step S67, the data link layer 80 reports a result of transmission to the network layer 70, in which the transmission result includes a success message SEND_OK.

In step S68, if the network status LineStatus was busy LINE_BUSY in step S64 or if the packet was not successfully transmitted in step S66, a retry count RetryCount for the received packet is increased by a predetermined value. For instance, although the retry count RetryCount in the beginning was set to ‘0’, the retry count RetryCount is increased to ‘1’.

In step S69, the increased retry count RetryCount is compared with a predetermined backoff repeat times BackOffRetries. The backoff repeat times BackOffRetries refers to a maximum value of retry counts for the retransmission of the same packet from the data link layer 80 to the physical layer 90. Also, in step S69, the retry count RetryCount for the same packet is limited to the backoff repeat times BackOffRetries, in order to prevent the network managers 20 to 23 and the electric devices 40 to 49 from using their resources only for the transmission of the same packet. If the retry count RetryCount is greater or equal to the backoff repeat times BackOffRetries, the method proceeds to the step S70, but otherwise the method proceeds to the step S71.

In step S70, the data link layer 80 reports a result of the packet transmission to the network layer 70, in which the result includes a failure message SEND_FAILED.

In step S71, the data link layer 80 compares a transmission execution time for the received packet with a predetermined maximum transmission allowable time MACExecTime. The transmission execution time refers to a total amount of time spent up to this comparison for the packet transmission. By limiting one-packet transmission time to any value below the maximum transmission allowable time MACExecTime, it becomes possible to prevent the network managers 20 to 23 and the electric devices 40 to 49 from using their resources only for the same packet. If the transmission execution time for the received packet is greater than the maximum transmission allowable time MACExecTime, the data link layer 80 reports the transmission failure message SEND_FAILED to the network layer 70 (S70). However, if the transmission execution time for the received packet is less than the maximum transmission allowable time MACExecTime, the method proceeds to the step S72.

In step S72, the competitive window Wc range is changed by a predetermined shift in dependence of the transmission priority SvcPriority of the received packet, and then the method proceeds to the step S61.

In effect, the Wc range is changed to improve the packet transmission probability Table 9A shows that the competitive window Wc range is reduced by decrement value WindowShift depending on the transmission priority.

TABLE 9A

| Transmission | | Competitive window | Decrement value |
|---|---|---|---|
| priority | Value | (Wc) range (IUT) | (WindowShift) (IUT) |
| High | 0 | 0-5 | 0 |
| Middle | 1 | 10-20 | 1 |
| Normal | 2 | 10-30 | 1 |
| Low | 3 | 30-60 | 3 |

Suppose that the competitive window Wc range is reduced as shown in Table 9A. In case of the middle transmission priority SvcPriority, the Wc range for the first transmission 10-20 is reduced to the range 9-19 for the second transmission having both lower and upper limits being reduced. This means that even smaller value than the transmission delay time RandomDelayTime selected in step S63 is more likely to be selected. Therefore, the network status LineStatus (Line_Status) can be checked again within a shorter amount of time, which in turn increases the packet transmission probability.

In step S72, it is also possible to reduce only one of the lower limit and the upper limit by the above-described decrement value WindowShift. For example, the data link layer 80 fixes the upper limit and reduces only the lower limit by the predetermined decrement value WindowShift according to the retry count RetryCount.

In step S72, it is important to ensure that the lower limit does not fall below a predetermined offset value. In so doing, the lower limit per transmission priority SvcPriority can maintain at least a predetermined interval. Therefore, even during the retransmission (or retry) of the packet, transmission probabilities are maintained at different values depending on transmission priority SvcPriority.

In addition, in step S72, to reduce a packet collision (probability) over the network, the competitive window Wc range is increased by decrement value WindowShift shown in Table 9B, depending on the transmission priority.

TABLE 9B

| Transmission | | Competitive window | Increment value |
|---|---|---|---|
| priority | Value | (Wc) range (IUT) | (WindowShift) (IUT) |
| High | 0 | 0-5 | 0 |
| Middle | 1 | 10-20 | 20 |
| Normal | 2 | 10-30 | 30 |
| Low | 3 | 30-60 | 60 |

Suppose that the competitive window Wc range is increased as shown in Table 9B. In case of the middle transmission priority SvcPriority, the Wc range for the first transmission 10-20 is increased to the range 30-40 for the second transmission having both lower and upper limits being increased by 20. This means that even larger value than the transmission delay time RandomDelayTime selected in step S63 is more likely to be selected. Therefore, the network status LineStatus (Line_Status) is checked again over a long period of time, which in turn reduces packet collisions over the network.

In step S72, it is also possible to increase only one of the lower limit and the upper limit by the above-described increment value WindowShift. For example, the data link layer 80 fixes the lower limit and increases only the upper limit by the predetermined increment value WindowShift according to the retry count RetryCount.

According to the data transmission method of the present invention, the steps S63, S64 and S72, the steps S68-S69, or the step S71 can optionally be included. That is, the data transmission method can be composed of all of the steps shown in FIG. 13, or part of them only.

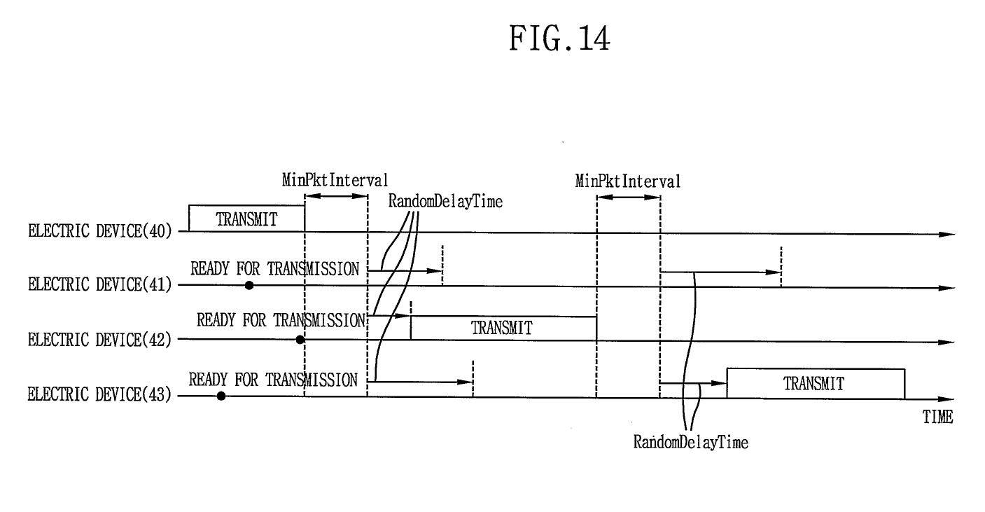

FIG. 14 illustrates frames that are processed in each electric device by the data transmission method according to the present invention.

In particular, FIG. 14 illustrates four electric devices 40 to 43 that are currently transmitting or are ready for transmitting a predetermined packet over the network. For instance, the electric device 40 is already in course of transmitting the packet, whereas the other electric devices 41 to 43 are ready for packet transmission.

Each of the electric devices 41 to 43 performs the step S61 (please refer to FIG. 13) to check the network status LineStatus. Then, for the minimum packet permitted time interval MinPktInterval since the transmission completion time of the electric device 40, the electric devices 41 to 43 perform the steps S62 and S63, to select transmission delay time RandomDelayTime according to the packet transmission priorities SvcPriority they received.

Referring back to FIG. 14, as time goes by, it turns out that the electric device 42 has the shortest the transmission delay time RandomDelayTime. Therefore, the electric device 42 transmits the packet (please refer to the steps S64 and S65 in FIG. 13), and the other electric devices 41 and 43 check the network status LineStatus during their transmission delay time RamdomDelayTime, and proceeds to the method after the step S68. After the electric device 42 transmits the predetermined packet, the electric devices 41 and 43 perform the same steps as described above.

As explained so far, the present invention provides the data transmission and receiving method for data link layer for use in the home network system based on the control protocol which is a general communication standard for providing functions of controlling and monitoring electric devices in the home network system.

According to the present invention, a plurality of only the relevant frames to a packet to be composed are received.

In addition, the present invention can be advantageously used for preventing an additional frame from being received and/or stored when a packet is already being composed of a plurality of received frames relevant to the packet.

According to the present invention, a packet from an upper layer can be more effectively transmitted, depending on the status of the network.

Also, the present invention can be advantageously used for preventing packet collisions over the network.

According to the present invention, the completion of packet transmission is performed according to the retry count during packet transmission. Therefore, it prevents the networked devices from using all their resources only for the packet transmission.

Moreover, according to the present invention, the completion of packet transmission is performed according to the transmission execution time spent in packet transmission. Therefore, it prevents the networked devices from using all their resources only for the packet transmission.

Furthermore, the present invention can be advantageously used for increasing successful packet retransmission probability by applying a variable transmission delay to packet transmission, which in turn makes the transmission based on the transmission priority performed stochastically.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A data receiving method for data link layer of a protocol that consists of a physical layer, a data link layer, and an upper layer, the method comprising the steps of:
receiving data from the physical layer;
storing the received data in a packet buffer;
deciding whether new data has been received within a predetermined data allowable interval time since last data is received; and
based on a result of the first decision, completing receiving the data.

2. The method of claim 1, wherein if, in the decision step, the new data is not received within the data allowable interval time, receiving the data is completed, whereas if the new data is received within the data allowable interval time, the new data is stored in the packet buffer.

3. The method of claim 1, further comprising the step of:
deciding whether the data link layer is ready for receiving data prior to the data receiving step, and if the data link layer is ready, receiving the data.

4. The method according to one of claim 1 to claim 3, further comprising the steps of:
composing a packet of data stored in the packet buffer; and
transmitting the composed packet to the upper layer.

5. The method of claim 4, further comprising the step of:
after the completion of receiving the data and before composing the packet, disabling the data link layer's data reception.

6. The method of claim 5, further comprising the step of:
after a lapse of a predetermined time since the packet transmission, enabling the data link layer's data reception.

7. The method of claim 6, wherein the predetermined time is a minimum packet permitted time interval (MinPktInterval).

8. The method of claim 7, wherein the minimum packet permitted time interval (MinPktInterval) is greater than a time spent at the upper layer in receiving the packet and completing packet processing.

9. The method of claim 1, wherein the protocol is a living network control protocol (LnCP).

10. A data transferring method for data link layer, wherein the data link layer is of a protocol comprising at least a physical layer, a data link layer and an upper layer, and a network based on the protocol is used for intercommunication between at least one electric device and at least one network manager in a home network system, and the data link layer transmits a packet from the upper layer to the physical layer, which the method comprises the steps of:
a first checking step for checking whether the network status is in an idle status;
according to a result of the first checking step, selecting a transmission delay time (RandomDelayTime);
a second checking step for checking whether the network status is an idle status during the selected transmission delay time (RandomDelayTime); and
according to a result of the second checking step, transmitting the received packet to the physical layer.

11. The method of claim 10, wherein the first network status checking step is performed during a minimum packet permitted time interval (MinPktInterval).

12. The method of claim 10, further comprising the step of:
making a first decision regarding whether the packet is successfully transmitted.

13. The method of claim 12, further comprising the step of:
based on a result of the first decision, reporting a result of packet transmission to the upper layer.

14. The method of claim 13, wherein if, in the first decision step, the packet is successfully transmitted, the transmission result comprises a success message (SEND_OK).

15. The method of claim 12, further comprising the steps of:
if, in the second checking step, the network status is busy or if, in the first decision step, the packet is not successfully transmitted, increasing a retry count (RetryCount) for the received packet by a predetermined value;
making a first comparison between the increased retry count (RetryCount) and a predetermined backoff repeat times (BackOffRetries); and
based on a result of the first comparison, transmitting a transmission result to the upper layer.

16. The method of claim 15, wherein if, in the first comparison step, the increased retry count (RetryCount) is greater than the backoff repeat times (BackOffRetries), the transmission result comprises a failure message (SEND_FAILED).

17. The method of claim 15, wherein if, in the first comparison step, the increased retry count (RetryCount) is less or equal to the backoff repeat times (BackOffRetries), performing all steps again starting from the first checking step.

18. The method according to one of claims 10 to 17, further comprising the step of:
making a second comparison between a transmission execution time of the received packet and a predetermined maximum transmission allowable time (MACExecTime),
wherein if, in the first checking step, the network status is busy or if, in the first comparison step, the increased retry count (RetryCount) is less or equal to the backoff repeat times (BackOffRetries), the second comparison step is performed.

19. The method of claim 18, further comprising the step of:
based on a result of the second comparison, transmitting a transmission result to the upper layer.

20. The method of claim 19, wherein if, in the second comparison step, the transmission execution time of the received packet is greater or equal to the maximum transmission allowable time (MACExecTime), the transmission result comprises a failure message (SEND_FAILED).

21. The method of claim 19, wherein if, in the second comparison step, the transmission execution time of the received packet is less than the maximum transmission allowable time (MACExecTime), performing all steps again starting from the first checking step.

22. The method of claim 21, wherein the transmission delay time (RandomDelayTime) is selected within a predetermined competitive window (Wc) range, according to service priority (SvcPriority) of the received packet.

23. The method of claim 23, further comprising the step of:
before performing the first checking step again, changing the competitive window (Wc) range by a predetermined size that is set according to the service priority (SvcPriority) of the received packet.

24. The method of claim 23, wherein, to increase a transmission probability, a lower limit and/or an upper limit of the competitive window (Wc) range is reduced by the size.

25. The method of claim 24, wherein the lower limit is reduced only to a predetermined offset value.

26. The method of claim 23, wherein, to reduce a transmission collision, a lower limit and/or an upper limit of the competitive window (Wc) range is increased by the size.

27. The method of claim 26, wherein the lower limit is fixed.

28. The method according to one of claims 12 to 14, wherein the first decision step comprises the sub-step of:
comparing the transmitted packet with the received packet, and based on a result of the comparison, deciding whether the packet is successfully transmitted.

29. The method of claim 10, wherein the protocol is a living network control protocol (LnCP).

30. A data transferring method for data link layer, wherein the data link layer is of a protocol comprising at least a physical layer, a data link layer and an upper layer, and a network based on the protocol is used for intercommunication between at least one electric device and at least one network manager in a home network system, and the data link layer transmits a packet from the upper layer to the physical layer, which the method comprises the steps of:
a first checking step for checking whether the network status is in an idle status;
according to a result of the first checking step, transmitting the received packet to the physical layer; and
making a first decision regarding whether the packet is successfully transmitted.

31. The method of claim 30, wherein the first network status checking step is performed during a minimum packet permitted time interval (MinPktInterval).

32. The method of claim 12, further comprising the step of:
based on a result of the first decision, reporting a result of packet transmission to the upper layer.

33. The method of claim 32, wherein if, in the first decision step, the packet is successfully transmitted, the transmission result comprises a success message (SEND_OK).

34. The method of claim 30, further comprising the steps of:
if, in the first decision step, the packet is not successfully transmitted, increasing a retry count (RetryCount) for the received packet by a predetermined value;
making a first comparison between the increased retry count (RetryCount) and a predetermined backoff repeat times (BackOffRetries); and
based on a result of the first comparison, reporting a transmission result to the upper layer.

35. The method of claim 34, wherein if, in the first comparison step, the increased retry count (RetryCount) is greater than the backoff repeat times (BackOffRetries), the transmission result comprises a failure message (SEND_FAILED).

36. The method according to one of claims 30 to 35, further comprising the step of:
making a second comparison between a transmission execution time of the received packet and a predetermined maximum transmission allowable time (MACExecTime),
wherein if, in the first checking step, the network status is busy or if, in the first comparison step, the increased retry count (RetryCount) is less or equal to the backoff repeat times (BackOffRetries), the second comparison step is performed.

37. The method of claim 36, further comprising the step of:
based on a result of the second comparison, transmitting a transmission result to the upper layer.

38. The method of claim 37, wherein if, in the second comparison step, the transmission execution time of the received packet is greater or equal to the maximum transmission allowable time (MACExecTime), the transmission result comprises a failure message (SEND_FAILED).

39. The method of claim 37, wherein if, in the second comparison step, the transmission execution time of the received packet is less than the maximum transmission allowable time (MACExecTime), performing all steps again starting from the first checking step.

40. The method of claim 30, wherein the first decision step comprises the sub-step of:
comparing the transmitted packet with the received packet, and based on a result of the comparison, deciding whether the packet is successfully transmitted.

41. The method of claim 30, wherein the protocol is a living network control protocol (LnCP).

42. A data transferring method for data link layer, wherein the data link layer is of a protocol comprising at least a physical layer, a data link layer and an upper layer, and a network based on the protocol is used for intercommunication between at least one electric device and at least one network manager in a home network system, and the data link layer transmits a packet from the upper layer to the physical layer, which the method comprises the steps of:
a first checking step for checking whether the network status is in an idle status;
according to a result of the first checking step, selecting a transmission delay time (RandomDelayTime) within a predetermined competitive window (Wc) range defined according to service priority SvcPriority of the received packet;
a second checking step for checking whether the network status is an idle status during the selected transmission delay time (RandomDelayTime); and
according to a result of the second checking step, transmitting the received packet to the physical layer.

43. The method of claim 42, wherein the first network status checking step is performed during a minimum packet permitted time interval (MinPktInterval).

44. The method of claim 42, further comprising the step of:
deciding whether the packet is successfully transmitted.

45. The method of claim 44, further comprising the step of:
based on a result of the decision, reporting a result of packet transmission to the upper layer.

46. The method of claim 44, wherein if the packet is successfully transmitted, the transmission result comprises a success message (SEND_OK).

47. The method according to one of claims 42 to 46, further comprising the step of:
comparing between a transmission execution time of the received packet and a predetermined maximum transmission allowable time (MACExecTime),
wherein if, in the first checking step, the network status is busy or if, in the first decision step, the packet is not successfully transmitted, the comparison step is performed.

48. The method of claim 47, further comprising the step of:
based on a result of the comparison, transmitting a transmission result to the upper layer.

49. The method of claim 48, wherein if, in the comparison step, the transmission execution time of the received packet is greater or equal to the maximum transmission allowable time (MACExecTime), the transmission result comprises a failure message (SEND_FAILED).

50. The method of claim 48, wherein if, in the comparison step, the transmission execution time of the received packet is less than the maximum transmission allowable time (MACExecTime), performing all steps again starting from the first checking step.

51. The method of claim 47, further comprising the step of:
before performing the first checking step again, changing the competitive window (Wc) range by a predetermined size that is set according to the service priority (SvcPriority) of the received packet.

52. The method of claim 51, wherein, to increase a transmission probability, a lower limit and/or an upper limit of the competitive window (Wc) range is reduced by the size.

53. The method of claim 52, wherein the lower limit is reduced only to a predetermined offset value.

54. The method of claim 51, wherein, to reduce a transmission collision, a lower limit and/or an upper limit of the competitive window (Wc) range is increased by the size.

55. The method of claim 54, wherein the lower limit is fixed.

56. The method according to one of claims 44 to 46, wherein the decision step comprises the sub-step of:
comparing the transmitted packet with the received packet, and based on a result of the comparison, deciding whether the packet is successfully transmitted.

57. The method of claim 42, wherein the protocol is a living network control protocol (LnCP).
